(19) United States
(12) Patent Application Publication
(10) Pub. No.: US 2004/0235335 A1
(43) Pub. Date: Nov. 25, 2004

(54) Cable connector

(76) Inventors: Pierre Schoeffel, Blotzheim (FR); Andrea Dominik Mastrovito, Munchensteim (CH)

Correspondence Address: Breiner & Breiner, 115 North Henry Street, PO Box 19290, Alexandria, VA, 22320-0290, US

(21) Appl. No.: 10/483,822

(22) PCT Filed: Apr. 26, 2002
(86) PCT No.: PCT/CH02/00234

(30) Foreign Application Priority Data
Sep. 3, 2001 (CH) 1636/01

(51) Int. Cl. H01R 4/24

(52) U.S. Cl. 439/410

(57) ABSTRACT

The invention relates to a cable connector that comprises an insulating body (1), composed of an upper part (2,3) and a lower part (4), said upper and lower parts (2, 3; 4) receiving and retaining the cables (5; 10) to be linked, and an intermediate part (3) being an integral part of the upper part and retaining the conducting contacting elements (6). Said contacting elements are provided with cutting points (6′-6′″) that project towards the lid part (2) being an integral part of the upper part or towards the lower part (4). When the upper, intermediate and lower parts (2, 3, 4) are assembled, the cutting points (6′-6′″) automatically pierce the insulations of the leads of the cable to be connected and penetrate the litz wires.

The present invention relates to a cable connector for a electrically conductive connecting of a continuous flat cable having several leads in form of litz wire conductors to at least one round cable having also several leads in form of litz wire conductors, with a connector upper part for a laterally separated receipt of the leads of a round cable dismantled in the foreseen connecting portion inside of the lid part and a connector lower part for the receipt of a continuous flat cable, as well as with electrically conducting contacting elements with cutting points for a piercing of the lead insulations and penetrating into the litz wires of the respective leads to be connected to each other.

At cable connectors of a conventional design the leads of the cables which are to be connected to each other must be interconnected in a complicated procedure by means of contacting elements which involves an extremely high workload. It has been an object of the present invention to provide a cable connector which is compact and of a simple design and by means of which the desired connection can be reached fast that is at a reduced working time.

This object has been solved at a cable connector of the kind set forth above in accordance with the invention by the features of the characterizing portion of claim 1.

Specific embodiments of the cable connector according to the present invention are defined in the depending claims.

Below, the invention will be explained somewhat more in detail by exemplary embodiments illustrated in the drawings. There is shown in:

FIG. 1 a cable connector in accordance with the present invention, partly assembled, in a perspective illustration;

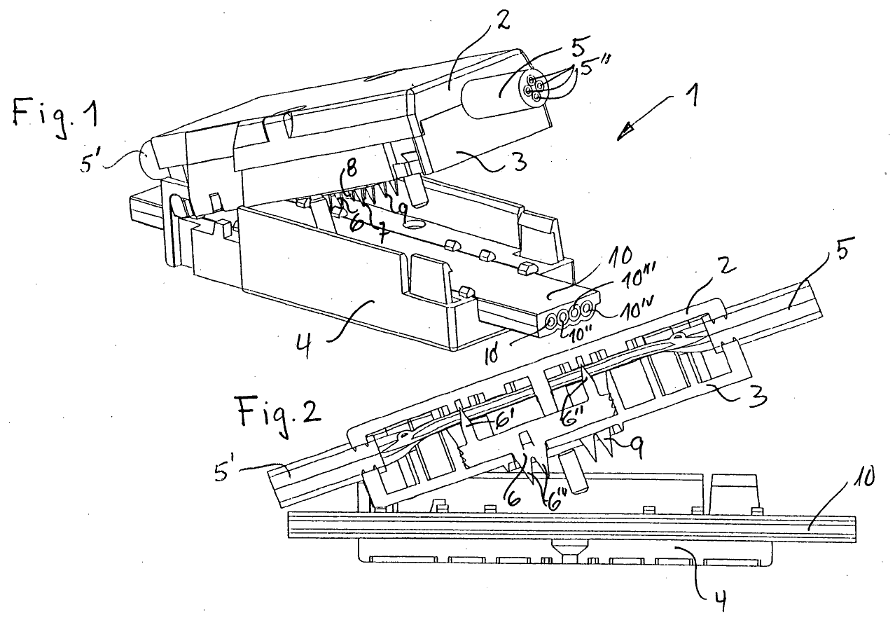

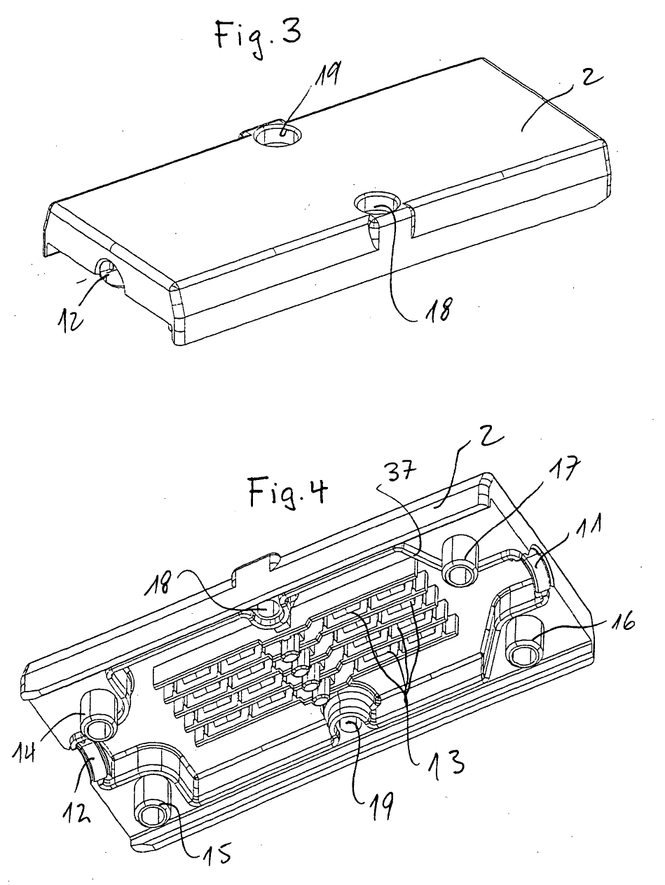

FIG. 2 a longitudinal section through a cable connector according to FIG. 1;

FIG. 3 the upper part of a cable connector in accordance of the invention, in a top view;

FIG. 4 the upper part of FIG. 3, from below;

FIG. 5 a top view of the intermediate part of the cable connector in accordance with the present invention;

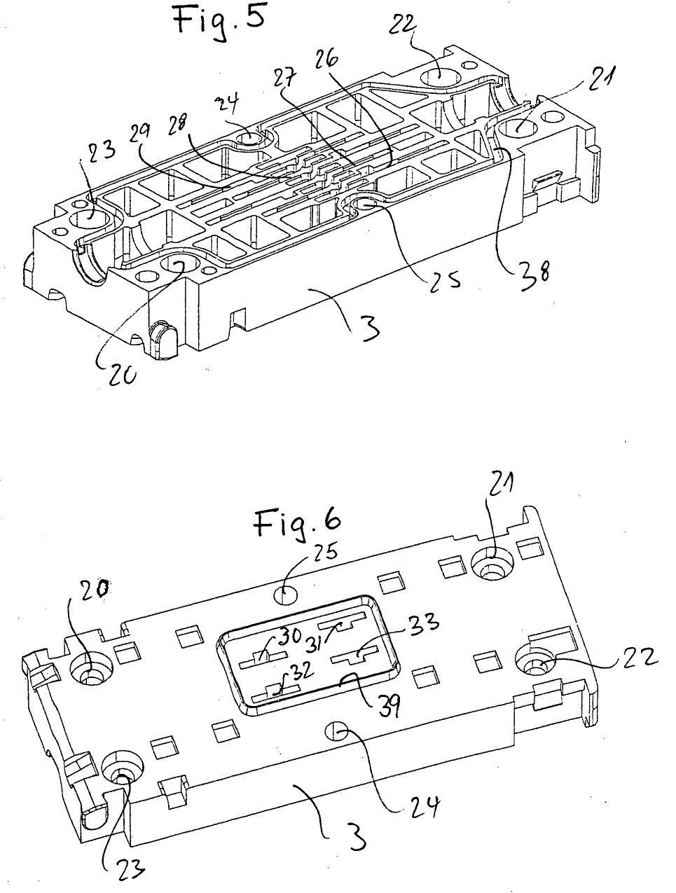

FIG. 6 the intermediate part of FIG. 5 from below;

FIG. 7 a view from above of the lower art of the cable connector in accordance with the present invention;

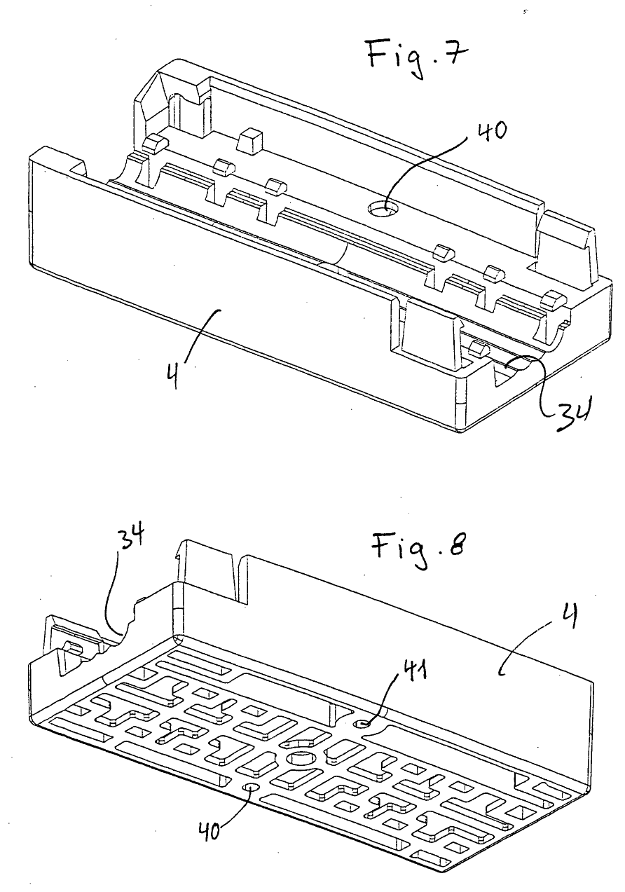

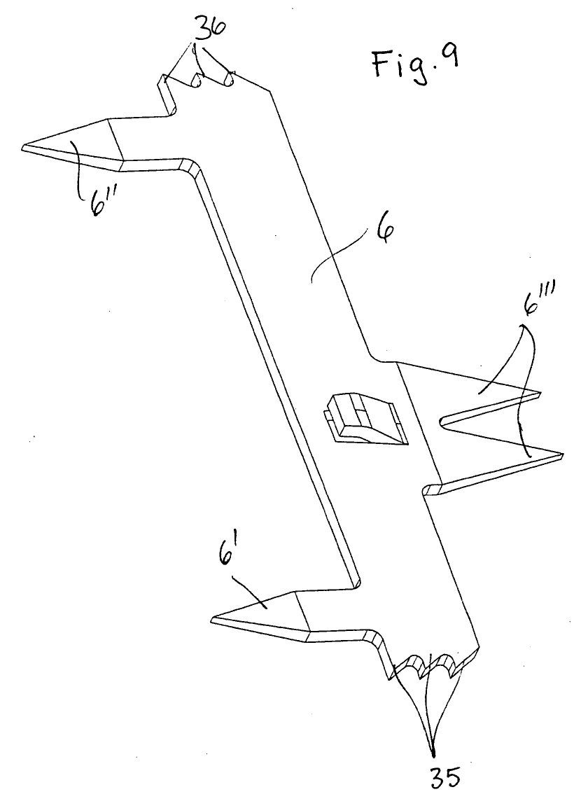

FIG. 8 the lower part of FIG. 7 from below;

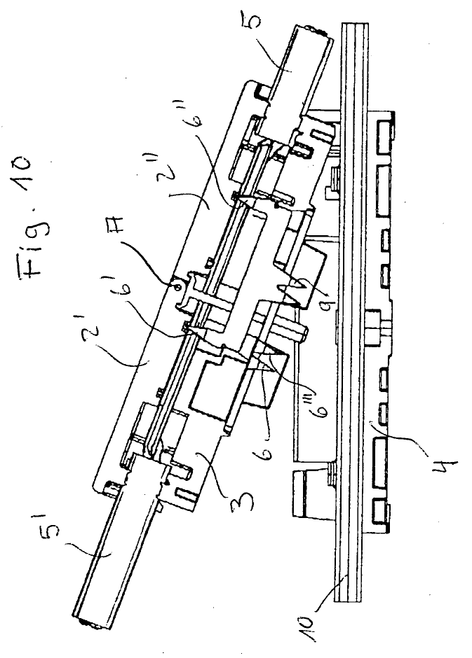

FIG. 9 on a enlarged scale, one of the contacting elements arrested in the intermediate part, and

FIG. 10 a longitudinal section such as FIG. 2 through a variant of a cable connector.

The drawing illustrates the cable connector 1 composed of lid part 2, intermediate part 3 and lower part 4 in various illustrations, that is a respective one part element 2, 3 and 4, resp. of the connector 1, the lid part 2 and intermediate part 3 form, assembled, the lid part.

In FIGS. 1 and 2 the cable connector 1 is illustrated in a partly assembled state, whereby lid and intermediate part 2, 3 with round cables 5, 5′ to be connected are already assembled kind of a hinge around which the parts 2, 3 can be pivoted towards the lower part 4, whereby the contacting elements 6-9 pierce the flat cable 10 set in the lower part 4 and anchor themselves in the litz wires of the leads 10^{I}-^{IV}. When pivoting the parts 2, 3 and 4, resp. they will lock into each other and thus produce the desired connection. In FIG. 2 it is illustrated how a respective contacting element 6 (and 7-9), which is located and held in the intermediate part 3, pierces by means of the cutting points 6′, 6″and 6′″, resp. projecting upwards and downwards the insulation of the leads 5″ of the cables 5, 5′ and 10, resp. and anchors itself in the desired litz wires. This takes place by itself during the assembling and mounting, resp. of lid part and intermediate part 2, 3 and intermediate part 3 and lower part 4, resp.

As also can be seen in FIG. 2, is how the round cables 5, 5′ are dismantled in the area of the desired connection, so that the individual leads 5″ (with insulation) are exposed and can be arranged side by side in the lid part.

The individual parts 2, 3 and 4 of the cable connector can be held together by snap elements or additionally by screws (not illustrated).

FIGS. 3 and 4 illustrate the lid part 2 in detail. Aside of the openings 11, 12 for the inserting of a round cable also guide grooves 13 for the receipt of the leads of the round cable can be seen (the round cable is dismantled behind the openings, so that the individual leads can be placed into the said grooves 13).

Guide bolts 14-17 are foreseen regarding a precise assembling with the intermediate part 3.

FIGS. 5 and 6 illustrate the intermediate part 3 of the cable connector 1. The intermediate part includes recesses 20-23 for the receipt of the guide bolts 14-17 of the lid part as well as screw bolt bore holes 24, 25. Important is the number of continuous slots 26-29 for the receipt and arresting of band shaped contacting elements (see FIG. 9) with cutting points projecting from the surfaces (the contacting elements are not shown here). The cutting points project directly from the surface facing upwards (towards the lid part 2), whereby they project downwards (towards the lower part 4) through openings 30-33.

FIGS. 7 and 8 illustrate the lower part 4 which is designed for the receipt and guiding of a multi-lead flat cable (not illustrated here). The recess 34 serves for the receipt of a continuous that is not interrupted flat cable.

The intermediate part 3 which is connected to the lid part 2 is set onto the lower part 4.

FIG. 9 illustrates a embodiment of a contacting element 6 to be arranged in the intermediate part 3 with cutting points 6′, 6″ (towards the lid part 2) and 6′″ (towards the lower part 4), resp. Sharp points 35, 36 are foreseen at the narrow ends of the band-shaped element 6 which serve for the clutching of the element 6 into the corresponding grooves 26-29 of the intermediate part 3.

The installation of a if necessary again releasable cable connector according to the invention for continuous cable-systems which are not to be interrupted proceeds such as will be described in the following:

An asymmetric flat cable 10 with litz wires 10^{I}-10^{IV} is inserted in accordance with known procedures into an asymmetrically designed connector-lower part 4.

The connector upper part 2, 3 is foreseen for the connecting of either one or two separate round cables 5, 5′ with litz wires 5″. If one or two such round cables 5, 5′ are to be connected, a round cable 5, 5′ is inserted through the one or both narrow sides of the connector upper part 2, 3 and dismantled about 10 mm behind the entry into the inner area of the lid part. The leads 5″ of the dismantled round cable with the variously colored lead insulations are placed into correspondingly variously color-marked grooves 13 in the lid part 2.

The connector—intermediate part 3 is arranged between the connector—lower part 4 and the connector—upper part 2, into which the contacting elements 6 with the cutting points 6′, 6″ and 6′″, resp. directed upwards and downwards, resp. for piercing the lead insulations. The two upper cutting points 6′, 6″of the contacting elements 6 are at such a distance from each other that the distance between the leads of two separately inserted Round cables can be bridged and the leads of the two cables can be pierced during the same working operation. The contacting elements comprise at the lateral ends sharp points 35, 36 by means of which they claw themselves into the insulating body of the intermediate part 3.

In order to insert the round cable 5 or round cables 5, 5′ the upper halves of circular insertion openings 11, 12 are formed into the narrow sides of the connector lid part 2 and the lower halves into the narrow sides of the connector intermediate part 3. In order to prevent humidity from reaching the contact areas the lid part includes a circumferential sealing rib 37 and the intermediate part a sealing groove 38. In order to allow a easy assembling of the lid part and the connector-intermediate part, the lid part is provided with guiding pins 14-17 and receiving holes 20-23 for these guiding pins 14-17 are formed in the intermediate part 3. Now, coming from the intermediate part 3, the guiding pins 14-17 of the lid part 2 are screwed through the receiving holes 20-23 into the intermediate part 3. By the tightening of the screws (not illustrated) the lead insulations of the litz wires of the round cable 5 or round cables 5, 5′ are pierced by the cutting points 6′, 6″ of the contacting elements facing upwards, the cable 5 or cables 5, 5′ inserted into the lid part 2 are clamped between the lid part 2 and the intermediate part 3 similar to a stress relieving and the sealing rib 37 is pressed into the sealing groove. At its bottom side, around the area where the cutting edges 6′″ for piercing the insulation of the flat cable leads 10^{I}-10^{IV} which face downwards project, the intermediate part 3 possesses also a sealing rib 39.

The connector-lower part 3 is formed at a narrow side for a hooking into the connector-lower part 4, whereby the intermediate part and the lower part 4 form together a pivot hinge. Whereas the intermediate part 3 and the lower part 4 engage each other at the narrow side of the hinge, the opposite ends of the narrow sides of the lower part 4 and the intermediate part 3 describe a gap similar to a beak (see FIG. 1 and 2). Now, the obliquely upwards oriented intermediate part 3 is pressed manually into the lower part 4 until it snaps into the lower part 4, so that it is initially arrested. The connector 1 is finally assembled for instance by the tightening of two lateral screws (not illustrated) in the screw holes 18, 19; 24, 25; 40, 41. Upon the tightening the cutting points 6′″ of the contact elements 6 which face downwards are pressed still further downwards, pierce the insulation of the flat cable leads 10^{I}-10^{IV} and penetrate into the litz wires wherewith the leads of the flat cable 10 are electrically connected to the corresponding leads 5″ of the round cable 5 or round cables 5′. At the same time the sealing rib 39 on the lower side of the intermediate part 3 is pressed onto the flat cable 10 and prevents the access of dampness to the contact areas in the lower part 4.

FIG. 10 illustrates a longitudinal section similar to FIG. 2 through a variant of a cable connector according to the present invention. Same parts (according to the first embodiment) are given the same reference numerals.

The most important difference from the first embodiment consists in that the leads of the round cables 5, 5′ are guided and held in the intermediate part 3 and that the lid part 2′, 2″ serves primarily to hold the round cable leads down and to press them into the cutting points 6′ 6″ of the contacting element.

The lid part consists of two separate parts 2′, 2″ which are pivotally hinged to the intermediate part 3 (pivot axis A).

This variant allows the connecting of the cable connector to round cables 5, 5′ in a simple manner not only in a workshop, but at any other place where such a connection is to be realized (placing the round cable leads into the intermediate part 3 followed by a closing of the lid part 5 and 5′, respectively).

1-8. (Canceled).

9. A cable connector for an electrically conductive connecting of a continuous flat cable having several litz wire lead conductors to at least one round cable having several litz wire lead conductors, comprising a connector first component for a laterally separated receipt of the lead conductors of the at least one round cable dismantled in a connecting portion inside of the first component, a connector second component for receiving a continuous flat cable, and electrically conducting contact elements with cutting points for piercing of insulations to and penetrating into the litz wire lead conductors of respective lead conductors to be connected to each other, wherein the connector first component comprises an upper part and a lower part which are connectable to each other, in a manner whereby the lead conductors of the at least one round cable to be connected are insertable between the upper part and the lower part, and that the contact elements are located and held in the lower part so that the cutting points of the contact elements project from both surfaces of the lower part opposite the upper part and said second component, respectively, so that the lead conductors to be connected to each other, upon connecting the upper part, the lower part and the second component, corresponding lead conductors are electrically connected to each other.

10. The cable connector according to claim 9, wherein the first component is structured for receipt of two separate round cables inserted from opposite directions, whereby the conducting contact elements located in the lower part include at least two cutting points projecting against the upper part, whereby the contact elements are at such a mutual distance from each other, that a respective cutting point pierces into one lead conductor of one or another, respectively, of the round cables.

11. The cable connector according to claim 9, wherein the contact elements held in the lower part are present in a number which corresponds to at least a number of the lead conductors of the flat cable.

12. The cable connector according to claim 10, wherein the contact elements held in the lower part are present in a number which corresponds to at least a number of the lead conductors of the flat cable.

13. The cable connector according claim 9, wherein the contact elements are flat sheet metal beams with cutting points projecting at both longitudinal sides.

14. The cable connector according claim 10, wherein the contact elements are flat sheet metal beams with cutting points projecting at both longitudinal sides.

15. The cable connector according claim 11, wherein the contact elements are flat sheet metal beams with cutting points projecting at both longitudinal sides.

16. The cable connector according to claim 13, wherein pointed projections are formed at lateral ends of the flat sheet metal beams in order to enable the contacting elements to claw into elongate recesses of the lower part.

17. The cable connector according to claim 14, wherein pointed projections are formed at lateral ends of the flat sheet metal beams in order to enable the contacting elements to claw into elongate recesses of the lower part.

18. The cable connector according to claim 15, wherein pointed projections are formed at lateral ends of the flat sheet metal beams in order to enable the contacting elements to claw into elongate recesses of the lower part.

19. The cable connector according to claim 11, wherein the upper part is constructed and arranged for receipt of the lead conductors of the at least one round cable and the lower part serves as a holder for the contact elements.

20. The cable connector according to claim 11, wherein the lower part is constructed and arranged for receipt and lateral guiding of the lead conductors of the at least one round cable and the upper part serves as a down holder for the lead conductors of the at least one round cable and urges the lead conductors into the contacting elements.

21. The cable connector according to claim 20, wherein the upper part includes two parts which are pivotally hinged at an intermediate part and wherein each of said two parts serves to connect one respective round cable.
